(19) United States
(12) Patent Application Publication
(10) Pub. No.: US 2008/0209498 A1
(43) Pub. Date: Aug. 28, 2008

(54) METHOD AND APPARATUS FOR RECORDING DIGITAL PROGRAMS AND STORAGE MEDIUM STORING PROGRAM SUPPLEMENTARY INFORMATION BY USING THE SAME METHOD

(75) Inventors: Hark-Joon Kim, Suwon-si (KR); Pil-Seung Yang, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 11/869,819

(22) Filed: Oct. 10, 2007

(30) Foreign Application Priority Data
Feb. 23, 2007 (KR) 10-2007-0018515

(51) Int. Cl. H04N 7/16; H04N 7/26; G11B 7/24

(52) U.S. Cl. 725/136; 386/124; 369/275.3

(57) ABSTRACT

A method and apparatus for recording digital program by transforming program supplementary information into graphic data are provided. The apparatus includes a supplementary information analyzer, a graphic data generator and a disk generator. The supplementary information analyzer extracts program supplementary information from a digital program signal and analyzes the program supplementary information. The graphic data generator transforms the program supplementary information outputted from the supplementary analyzing unit into graphic data, and a disk generator records the digital program signal and the graphic data generated from the graphic data generator in a disk.

### CROSS-REFERENCE TO RELATED PATENT APPLICATIONS

This application claims priority from Korean Patent Application No. 10-2007-0018515, filed on Feb. 23, 2007, in the Korean Intellectual Property Office, the disclosure of which is incorporated herein in its entirety by reference.

### BACKGROUND OF THE INVENTION

1. Field of the Invention

Methods and apparatuses consistent with the present invention relate to recording digital programs, and more particularly, to recording digital program data by transforming program supplementary information into graphic data.

2. Description of the Related Art

Since digital television (TV) broadcasting uses a digital signal such as a transport stream (TS), a user can store broadcast program data in a storage medium such as a digital versatile disk (DVD), a hard disk drive (HDD), a flash memory, or a digital data device, and reproduce the stored broadcast program data using a typical multimedia reproducing device such as a DVD player.

As shown in FIG. 1, a conventional digital broadcast program recorder/player 11 records a received broadcast program in an original data format such as a transport stream (TS) into a storage medium, for example, a disk 12. The recorder/player 11 decodes the recorded broadcast program or TS data and transmits the decoded data to a display 13, for example, a TV.

The decoded TS data includes program supplementary information as well as a video stream and an audio stream. A program and system information protocol (PSIP) is an example of the representative program supplementary information. Such program supplementary information includes information necessary to reproduce a program (e.g. electronic program guide (EPG) information, caption information, etc) using the TS packets.

However, since the player 11 does not generally have digital TV functions, the player 11 cannot provide the supplementary functions (e.g. EPG, caption, etc) using the program supplementary information. Even when the display 13 is a digital TV and connected to the player 11 through an interface such as a high-definition multimedia interface (HDMI), a component interface, or a composite video burst signal (CVBS) interface, the display 13 (or digital TV) cannot interpret the program supplementary information because the TS data transmitted from player 11 to the TV was changed when it was recorded.

### SUMMARY OF THE INVENTION

The present invention provides a digital program data recording method and apparatus for enabling a reproducing device having no digital TV function to use program supplementary information, and a storage medium for storing program supplementary information.

According to an aspect of the present invention, there is provided a digital program recording apparatus including a supplementary information analyzer for extracting program supplementary information data from a digital program signal and analyzing the program supplementary information data; a graphic data generator for transforming the supplementary information outputted from the supplementary information analyzer into graphic data; and a disk generator for recording the digital program signal and the graphic data generated from the graphic data generator in a disk.

According to another aspect of the present invention, there is provided a digital program recording method including extracting program supplementary information included in a digital program signal and analyzing the extracted program supplementary information; transforming the program supplementary information into graphic data; and storing the digital program signal and the graphic data in a storage medium.

According to another aspect of the present invention, there is provided a computer readable storage medium for storing digital broadcast program data, wherein video data and audio data among the program data have the structure of TS data, and wherein the supplementary information data among the program data has the structure of graphic data that an optical disk can support.

According to another aspect of the present invention, there is provided a digital program reproducing apparatus including a disk for storing digital program signal comprising video data, audio data, and graphic data including program supplementary information of a digital broadcast program; an audio decoder for decoding the audio data recorded in the disk; a video decoder for decoding the video data recorded in the disk; and a graphic data decoder for decoding graphic data recorded in the disk.

### BRIEF DESCRIPTION OF THE DRAWINGS

The above and other aspects of the present invention will become more apparent by describing in detail exemplary embodiments thereof with reference to the attached drawings, in which:

FIG. 1 is a scenario illustrating a method and apparatus for recording and reproducing digital a broadcast program according to a related art;

FIG. 2 is a block diagram illustrating an apparatus for recording a digital broadcast program according to an exemplary embodiment of the present invention;

FIG. 3 is a flowchart illustrating a method of recording a digital broadcast program according to an exemplary embodiment of the present invention;

FIG. 4 is a diagram for describing the operation of a method of recording a digital broadcast program according to an exemplary embodiment of the present invention;

FIG. 5 is a block diagram illustrating an apparatus for reproducing a recorded digital broadcast program according to an exemplary embodiment of the present invention; and

FIGS. 6A and 6B are diagrams illustrating a recorded digital broadcast program displayed by a video output unit according to an exemplary embodiment of the present invention.

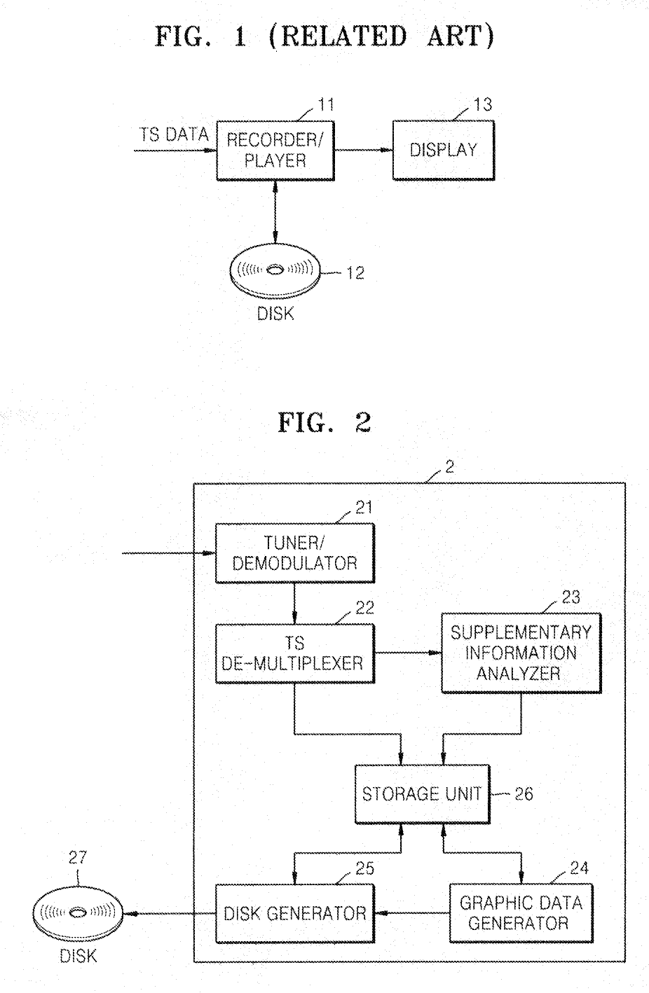

### DETAILED DESCRIPTION OF THE INVENTION

The present invention will now be described more fully with reference to the accompanying drawings, in which exemplary embodiments of the invention are shown.

FIG. 2 is a block diagram illustrating an apparatus for recording a digital broadcast program according to an embodiment of the present invention;

First, digital broadcast signals are received by a recorder 2 through a wired/wireless channel. A tuner 21 band-filters the broadcast signals to obtain a broadcast signal having a broadcast program that is desired to be recorded. A demodulator 21 demodulates the broadcast signal filtered by the tuner and outputs a transport stream (TS) of a bit sequence.

A TS de-multiplexer 22 separates the transport stream (TS) into TS data, that is, video data, audio data, and program supplementary information data, by de-multiplexing the TS received from the demodulator 21.

A program supplementary information analyzer 23 extracts the program supplementary information from the TS data separated by the TS de-multiplexer 22, and parses the extracted program supplementary information. The supplementary information analyzer 23 also selectively performs a signal processing for editing the program supplementary information or a signal processing for transforming the format of the program supplementary information in order to enable a typical multimedia reproducing apparatus to easily perform decoding.

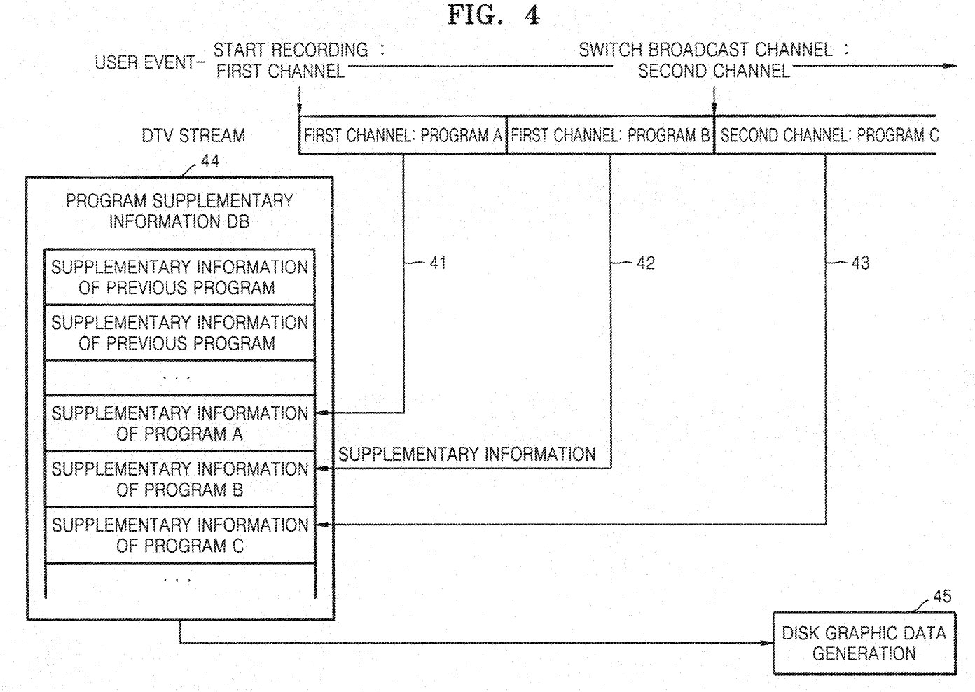

A storage unit 26 stores the TS data separated by the TS de-multiplexer 22, and the program supplementary information analyzed and/or processed by the supplementary information analyzer 23. The storage unit 26 can store the program supplementary information received from the supplementary information analyzer in the form of a database (DB), for example, a program supplementary DB shown in FIG. 4. The DB may store program supplementary information of previously recorded programs as well as program supplementary information of programs currently being recorded.

The storage unit 26 may store all the TS data, such as video data, audio data, and program supplementary information data, outputted from the TS de-multiplexer 22 or may store only a part of the TS data including a broadcast program a user wants to record. A typical storage medium, for example, a hard disk drive (HDD), a volatile memory such as random access memory (RAM), or a non-volatile memory such as read only memory (ROM), may be used as the storage unit 26.

A graphic data generator 24 transforms program supplementary information into graphic data. When a user selects programs that are to be recorded using a program supplementary information DB stored in the storage unit 26, the graphic data generator 24 extracts program supplementary information related to the selected programs and transforms the extracted program supplementary information into graphic data. The transformed program supplementary information can be sorted according to the user's setting, for example, broadcasting dates, and the genre of programs.

The format of graphic data according to the present exemplary embodiment must be supported by an optical disk and must be recognizable to a typical multimedia reproducing device. Examples of representative graphic data formats are a Blu-ray Disk (BD) format and a high definition digital video disk (HD DVD) format. The format of the graphic data generated according to the present exemplary embodiment must comply with the specification of one of those standards (BD, HD DVD).

A disk generator 25 stores program data selected by a user in a disk 27. That is, the disk generator 25 receives graphic data related to programs that are to be recorded from the graphic data generator 24, obtains TS data from the storage unit 26, and records the received graphic data and the obtained TS data in the disk 27. The format of the graphic data to be recorded should be compatible with the recording format of an optical disk.

The disk generator 25 may read out all the TS data stored in the storage unit and store it onto the disk. The disk generator 25 may also extract data related to a program that is to be recorded from all the TS data. This is because the TS data may include data related to a plurality of programs, as is the case with the MPEG-2 standard.

It is preferable, but not necessary, that the disk 27 is a large capacity optical disk. It is also preferable, but not necessary, that the disk 27 supports the graphic data format.

In another exemplary embodiment of the present invention, the disk 27 may be designed to store TS data separated by the TS de-multiplexer 22 and program supplementary information DB analyzed and processed by the supplementary information analyzer 23 in stead of the storage unit 26.

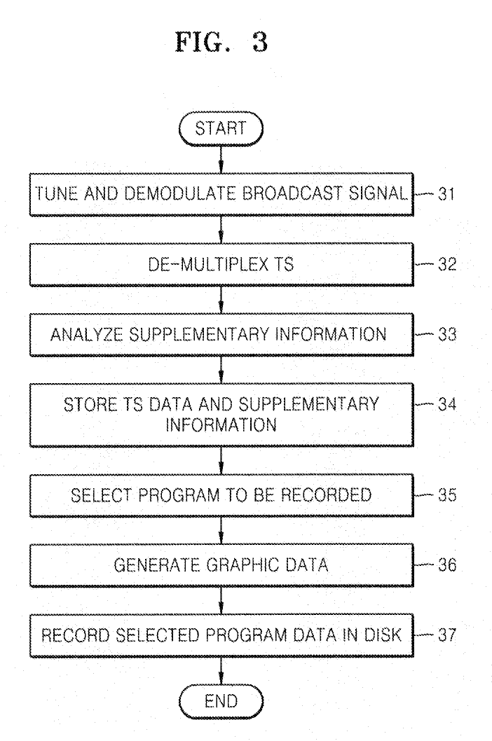

FIG. 3 is a flowchart illustrating a method of recording a digital broadcast program according to an exemplary embodiment of the present invention.

In operation S31, a TS of a real bit sequence is obtained by filtering a broadcast signal of a channel providing a broadcast program that is to be recorded from digital TV broadcast signals and demodulating the filtered signal.

In operation S32, the obtained TS is de-multiplexed. That is, the obtained TS is separated into TS data including video data, audio data, and program supplementary information data, by de-multiplexing the obtained TS.

In operation S33, the program supplementary information is extracted and parsed. In operation S33, a processing and transforming operation may be performed to edit the extracted program supplementary information or to transform the format of the extracted program supplementary information so as to enable a typical multimedia reproducing device to easily decode the program supplementary information.

In operation S34, the TS data de-multiplexed in operation S32 and the program supplementary information analyzed and/or processed in operation S33 are stored in a general storage medium such as an HDD. In operation S34, while all the TS data, such as video data, audio data, and program supplementary information data, outputted from the TS de-multiplexer 22 may be stored, only a part of the TS data including a broadcast program a user wants to record may be stored.

In operation S35, a user selects a target broadcast program to record onto a disk using a user interface (not shown). In operation S35, the user may select a program using the program supplementary information DB.

In operation S36, only the program supplementary information related to the selected programs in operation S35 is extracted and the extracted program supplementary information is transformed into the graphic data.

In operation S37, the selected program data is stored in the disk 27. That is, the stored graphic data and the TS data, necessary to reproduce the selected program, are read from the storage unit 26, and the read graphic and TS data are recorded in the disk 27. In another exemplary embodiment of the present invention, the graphic data generated in operation S36 is stored in the storage unit 26 instead of being stored in the disk 27, and then the stored graphic data may be transmitted to an external device, such as a TV or PC, through a communication link.

Although the TS data stored in the disk can include all the TS data stored in operation S34, the data of a target program that is to be recorded is extracted from all the TS data and only the extracted data can be recorded in the disk.

FIG. 4 is a diagram for describing an operation of a method of recording a digital broadcast program according to an exemplary embodiment of the present invention.

When a user selects a first channel to record a broadcast program, the recorder 2 receives a TS or a DTV stream of the first channel. The received TS is transformed into TS data by performing demodulation and de-multiplexing, and the TS data is stored in a storage unit. The program supplementary information 41 and 42 of programs A and B included in the TS data is analyzed and/or processed, and the analyzed and processed data is stored in the program supplementary information DB 44.

If a user switches the broadcast channel from the first channel to a second channel 2, TS data of the second channel is received. Then, program supplementary information 43 of a program C included in the received TS data is analyzed and/or processed, and the analyzed and processed program supplementary information of the program C is stored in the program supplementary information DB 44.

Then, a user selects programs that are to be recorded in a disk 27 using the program supplementary information DB 44, disk graphic data 46 is generated using the program supplementary information of the selected programs.

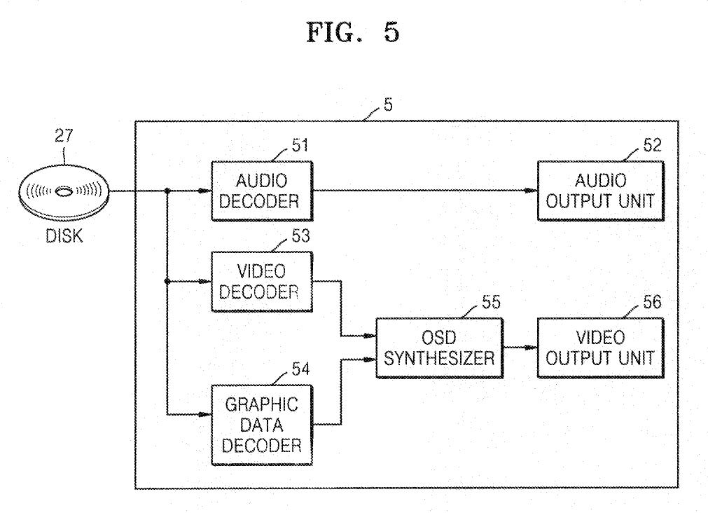

FIG. 5 is a block diagram illustrating the structure of an apparatus for reproducing a digital broadcast program recorded according to an exemplary embodiment of the present invention.

Audio data from among TS data recorded in the disk 27 is input to an audio decoder 51. Then, the audio decoder 51 decodes the audio data and outputs the decoded audio data through an audio output unit 52, which is, for example, a speaker or an earphone.

Video data from among the TS data recorded in the disk 27 is input to a video decoder 53. The video data decoded by the video decoder 53 is outputted through an on screen display (OSD) synthesizer 55.

Graphic data recorded in the disk 27 is input to a graphic data decoder 54. The graphic data decoder 54 decodes the graphic data and outputs the decoded graphic data to the OSD synthesizer 55.

The OSD synthesizer 55 combines the input signal into one image and displays the image by using the video output unit 56, which is, for example, a display device.

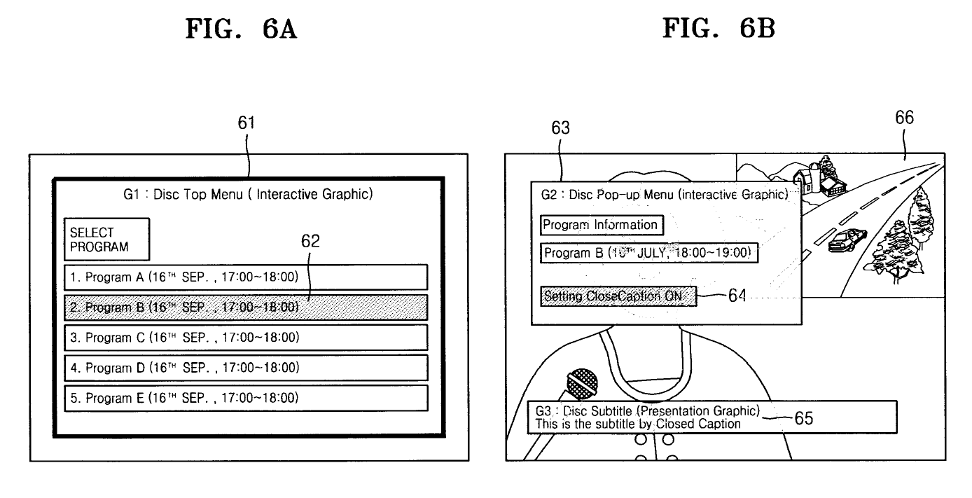

FIGS. 6A and 6B are diagrams illustrating a recorded digital broadcast program reproduced and displayed by the video output unit 56 according to an exemplary embodiment of the present invention.

When a user requests reproduction of a program stored in the disk 27, the reproducing device 5 decodes graphic data stored in the disk 27. FIG. 6A shows a top menu 61 generated using electronic program guide (EPG) data included in the decoded graphic data (or program supplementary information). The top menu 61 shows a program list as an interactive graphic G1. When a user selects a program B 62 from the program list, the reproducing apparatus 5 decodes the TS data including video and audio data of the program B stored in the disk 27 and respectively outputs a decoded image 66 as shown in FIG. 6B and voice through the output units 52 and 56.

FIG. 6B shows another menu G2 63 that pops up on the image 66. The menu G2 63 shows detailed information of the program B. The menu G2 63 is also formed as an interactive graphic.

If a user sets a caption setting-up item 64 included in the menu G2 63 to “ON”, a caption G3 65 is displayed on the image 66. The caption G3 65 may be formed as a presentation graphic.

According to the exemplary embodiment of the present invention, a typical reproducing apparatus having no digital TV function may be enabled to provide digital broadcast program supplementary information, thereby improving convenience for a user.

Also, the digital broadcast reproducing apparatus according to the exemplary embodiment of the present invention is economic because it does not require a digital TV function module.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A digital program recording apparatus comprising:
a supplementary information analyzer which extracts program supplementary information from a digital program signal comprising video data, audio data and program supplementary information data, and analyzes the program supplementary information;
a graphic data generator which transforms the program supplementary information outputted from the supplementary information analyzer into graphic data; and
a disk generator which records the digital program signal and the graphic data generated from the graphic data generator in a disk.

2. The digital program recording apparatus of claim 1, further comprising a storage unit which stores the digital program signal and the program supplementary information analyzed by the supplementary information analyzer.

3. The digital program recording apparatus of claim 1, further comprising a de-multiplexer which de-multiplexes the digital program signal.

4. The digital program recording apparatus of claim 1, wherein the supplementary information analyzer selectively performs at least one of a signal processing operation to edit the program supplementary information and a signal processing operation to transform a format of the program supplementary information to enable the program supplementary information to be reproduced.

5. The digital program recording apparatus of claim 2, wherein the storage unit stores an entire portion of the digital program signal or a portion of the digital program signal.

6. The digital program recording apparatus of claim 2, wherein the storage unit stores the program supplementary information in a database.

7. The digital program recording apparatus of claim 6, wherein the database includes at least one of program supplementary information of previously recorded programs and program supplementary information of programs currently being recorded.

8. The digital program recording apparatus of claim 1, wherein the graphic data generator transforms an entire portion of the program supplementary information or a portion of the program supplementary information stored in the storage unit according to a selection of a user.

9. The digital program recording apparatus of claim 1, wherein a format of the graphic data corresponds to one of a Blue-ray disk format and a high definition digital video disk format.

10. The digital program recording apparatus of claim 1, wherein the disk is an optical disk.

11. The digital program recording apparatus of claim 10, wherein the optical disk supports a graphic data format.

12. A digital program recording method comprising:
extracting program supplementary information included in a digital program signal comprising video data, audio data and program supplementary information data, and analyzing the program supplementary information;
transforming the program supplementary information into graphic data; and
storing the digital program signal and the graphic data in a storage unit.

13. The digital program recording method of claim 12, further comprising storing the digital program signal and the program supplementary information.

14. The digital program recording method of claim 12, wherein the storage unit is an optical disk.

15. The digital program recording method of claim 13, wherein in the storing of the program supplementary information, the program supplementary information is stored in a database.

16. The digital program recording method of claim 15, wherein the digital program data recording method allows a user to select one or more programs by using the database of the program supplementary information.

17. The digital program recording method of claim 16, wherein in the storing of the digital program signal in the storage unit, only data of a program selected by the user is stored in the storage unit.

18. The digital program recording method of claim 13, wherein a format of the graphic data corresponds to one of a Blue-ray disk format and a high definition digital video disk format.

19. A computer readable storage medium for storing digital program signal comprising video data, audio data and program supplementary information data,
wherein the video data and the audio data have a structure of transport stream, and
wherein the program supplementary information data has a structure of graphic data that an optical disk can support.

20. The computer readable storage medium of claim 19, wherein a format of the graphic data corresponds to one of a Blue-ray disk format and a high definition digital video disk format.

21. A digital program reproducing apparatus comprising:
a disk which stores digital program signal comprising video data, audio data, and graphic data comprising program supplementary information;
an audio decoder which decodes the audio data;
a video decoder which decodes the video data; and
a graphic data decoder which decodes the graphic data.
